(19) United States
(12) Patent Application Publication
(10) Pub. No.: US 2026/0244669 A1
(43) Pub. Date: Aug. 20, 2026

(54) COMBINING STRUCTURED AND UNSTRUCTURED DATA FOR RAG

(71) Applicant: SAP SE, Walldorf (DE)

(72) Inventors: Christian HOLZER, Ubstadt-Weiher (DE); Karsten SCHASER, Wiesloch (DE); Georg WILHELM, Walldorf (DE); Daniel WACHS, Mutterstadt (DE); Christian FUHLBRUEGGE, Spechbach (DE); Uwe SCHLARB, Ostringen (DE); Rene DEHN, Sinsheim (DE); Raphael MUESSELER, Dusseldorf (DE); Robin PFAFF, Linsengericht (DE)

(21) Appl. No.: 19/058,866

(22) Filed: Feb. 20, 2025

(51) Int. Cl. G06F 16/334; G06F 16/22; G06F 16/93

(52) U.S. Cl. CPC G06F 16/3347; G06F 16/2237; G06F 16/2264; G06F 16/93

(57) ABSTRACT

A system and method include identification of a plurality of stored multi-dimensional numerical vectors similar to a first multi-dimensional numerical vector representing the received text, identification of a first plurality of documents associated with respective ones of the identified plurality of stored multi-dimensional numerical vectors, determination of a second plurality of the first plurality of documents which are associated with a respective metadata value of the first metadata field, and prompting of a text generation model to determine relevancies of each metadata value to the received text based on the second plurality of documents.

### BACKGROUND

Modern organizations generate and store vast amounts of data. Users operate applications which provide sophisticated functions based on the data as well as analysis and reporting over such data. Despite advances, it remains challenging for novice users to effectively use or customize these applications.

Modern generative AI models provide generation of text, images and even sound based on user-submitted prompts. These models may be trained on a vast corpus of available data so as to be generally usable for all intended purposes. Due to the breadth of the knowledge acquired via such training, it may be difficult to narrow the scope of responses provided by a model to a desired field. Moreover, these models might not possess the knowledge required to adequately respond to prompts associated with specialized domains.

To address the foregoing, one approach includes fine-tuning a generative AI model using domain-specific information which was not included within the initial training corpus. This approach is costly and might not achieve the desired results. Alternatively, Retrieval Augmented Generation (RAG) describes a process to retrieve information specific to a query from a RAG corpus consisting of unstructured information (i.e., documents). The retrieved information is incorporated into the context of a prompt which also includes the query, and the prompt is input to a generative AI model. RAG may improve response accuracy and mitigate hallucinations which can result from queries which relate to topics on which the generative model has not been trained.

The RAG corpus is populated by encoding the semantics of each stored document into a numerical vector (i.e., an embedding). Retrieval of query-specific information from the RAG corpus includes encoding an embedding of a user query and comparing this embedding with the stored embeddings to find the closest-fitting stored documents. Unfortunately, incorporating all relevant stored documents into a prompt can easily exceed the maximum permitted number of input tokens to the model or can be prohibitively expensive.

Systems are desired to efficiently provide effective RAG while limiting the number of input tokens added to model prompts.

### BRIEF DESCRIPTION OF THE DRAWINGS

FIG. 1 illustrates a system to provide retrieval augmented generation based on associations between unstructured and structured data according to some embodiments.

FIG. 2 is a block diagram illustrating associations between unstructured and structured data of a software application according to some embodiments.

FIG. 3 depicts flow diagrams of processes to populate a retrieval augmented generation data store using associations between unstructured and structured data of a software application according to some embodiments.

FIG. 4 is a block diagram illustrating population and usage of a retrieval augmented generation data store using associations between unstructured and structured data of a software application according to some embodiments.

FIG. 5 illustrates population of a retrieval augmented generation data store according to some embodiments.

FIGS. 6A and 6B are a flow diagram of a process to respond to a user query using a retrieval augmented generation data store including associations between unstructured and structured data of a software application according to some embodiments.

FIG. 7 is a user interface of an extensibility application according to some embodiments.

FIG. 8 is a user interface of an extensibility AI assistant according to some embodiments.

FIG. 9 is a block diagram illustrating generation of a prompt according to some embodiments.

FIG. 10 is a user interface of an extensibility AI assistant according to some embodiments.

FIG. 11 is a user interface of an extensibility AI assistant according to some embodiments.

FIG. 12 is a user interface of an extensibility AI assistant according to some embodiments.

FIG. 13 is a user interface of an extensibility AI assistant according to some embodiments.

FIG. 14 is a user interface of an extensibility application according to some embodiments.

FIG. 15 is a diagram of a cloud-based implementation according to some embodiments.

### DETAILED DESCRIPTION

The following description is provided to enable any person in the art to make and use the described embodiments. Various modifications, however, will be readily-apparent to those in the art.

Some embodiments provide and utilize a RAG corpus which contains unstructured documents and links between the unstructured documents and related structured metadata. With respect to the examples described below, a RAG corpus may include unstructured technical documentation of a software application and structured content associated with the documentation. The structured content may consist of extensible entities and/or other application artifacts determined from database tables of the application. Logically, each entity/artifact is typically associated with only a small subset of the unstructured technical documentation.

In operation, unstructured documents may be retrieved from the RAG corpus using typical RAG techniques. The structured metadata associated with the retrieved unstructured documents may then be used to filter the retrieved unstructured documents to a relevant subset thereof. For example, any retrieved documents which are associated with metadata referencing objects which do not belong to the object types of interest may be discarded. Embodiments may thereby reduce the number of retrieved documents which are added to a text generation prompt while maintaining the efficacy of the prompt.

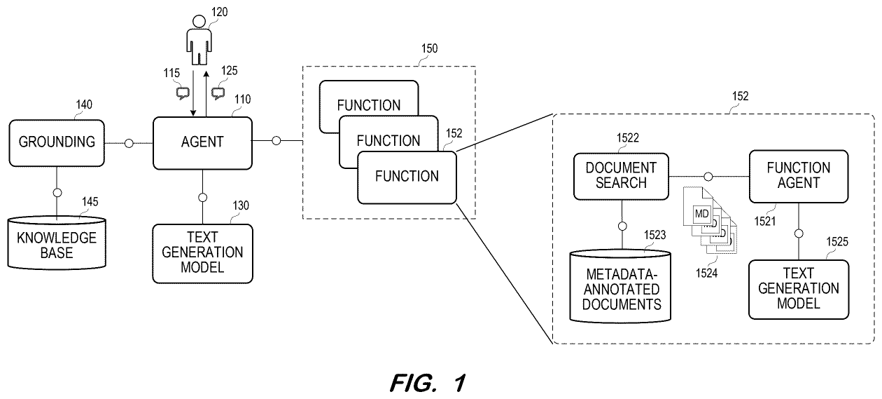

FIG. 1 illustrates a system to provide retrieval augmented generation based on associations between unstructured and structured data according to some embodiments. Each of the illustrated components may be implemented using any suitable combination of local, on-premise, cloud-based, distributed (e.g., including distributed storage and/or compute nodes) computing hardware and/or software that is or becomes known. Each component described herein may be executed by one or more physical and/or virtualized servers.

Two or more components of FIG. 1 may be co-located. In some embodiments, two or more components are implemented by a single computing device. One or more components may be implemented by a cloud service (e.g., Software-as-a-Service, Platform-as-a-Service). A cloud-based implementation of any components of FIG. 1 may apportion computing resources elastically according to demand, need, price, and/or any other metric. Each component may be executed by an execution environment comprising one or more servers, virtual machines, clusters of a container orchestration system, etc. Such an execution environment may provide an operating system, services, I/O, storage, libraries, frameworks, etc. to applications executing therein.

Generally, agent 110 receives text input 115 from users such as user 120 operating a user device (not shown) and provides a response 125 thereto. Response 125 may be generated by prompting text generation model 130 using a prompt including user input 115. Text generation model 130 may comprise a neural network trained to generate text based on input text.

According to some embodiments, model 130 is a Large Language Model (LLM) conforming to a transformer architecture. Non-exhaustive examples of an LLM include GPT-4, LaMDA, Claude or the like. A transformer architecture may include, for example, embedding layers, feedforward layers, recurrent layers, and attention layers. An embedding layer creates embeddings from input text, intended to capture the semantic and syntactic meaning of the input text. A feedforward layer is composed of multiple fully-connected layers that transform the embeddings. Some feedforward layers are designed to generate representations of the intent of the text input. A recurrent layer interprets the tokens (e.g., words) of the input text in sequence to capture the relationships between the tokens. Attention layers may employ self-attention mechanisms which are capable of considering different parts of input text and/or the entire context of the input text to generate output text. Generally, each layer includes nodes which are connected to the input of nodes of a subsequent layer to form a directed and weighted graph. Each node receives input, changes its internal state according to that input, and produces an output depending on the input and internal state.

Text generation model 130 may be implemented by, for example, executable program code, a set of hyperparameters defining a model structure and a set of corresponding weights, or any other representation of an input-to-output mapping which was learned as a result of the training. Model 130 may be publicly available or deployed within a trusted landscape. Similarly, text generation model 130 may be trained based on public and/or private data.

Agent 110 may call grounding component 140 to identify documents or other text information from knowledge base 145 based on text input 115. The identified information is added to the prompt and is intended to provide context to model 130 for responding to the prompt.

To populate knowledge base 145, potentially-relevant (e.g., domain-specific) documents are acquired. The documents are broken down into text portions, or “chunks” using any chunking algorithm that is or becomes known. Each chunk is converted to a multi-dimensional numerical vector (i.e., an embedding) which is intended to capture the semantic and syntactic meaning of the chunk. The conversion is performed such that embeddings of semantically-similar chunks are close to one another in vector space, and embeddings of semantically-dissimilar chunks are far from one another in vector space. Knowledge base 145 stores each embedding in association with an identifier of the document from which its associated chunk was obtained.

To retrieve documents from knowledge base 145, grounding component 140 generates an embedding representing the semantics of text input 115. Grounding component 140 conducts a similarity search (e.g., based on cosine similarity) to identify embeddings of knowledge base 145 which are similar to the generated embedding. Documents associated with the identified embeddings are retrieved and returned to agent 110 for inclusion into a prompt.

The prompt may include information describing function calls using which agent 110 may call one or more of functions 150. As will be described in detail below, and based on the prompt, text generation model 130 may determine that function 152 should be called and return parameter values for calling function 152 to agent 110. Agent 110 then calls function 152 using the parameter values. The parameter values may include text input 115.

FIG. 1 illustrates components of function 152 according to some embodiments. Function agent 1521 requests relevant documents from document search component 1522. Component 1522 may operate as described above with respect to grounding component 140 to generate an embedding based on the parameter values and to use the embedding to locate one or more similar documents from metadata-annotated documents 1523.

Metadata-annotated documents 1523 may comprise unstructured technical documents describing aspects of a software application and structured metadata of the software application. Specifically, each technical document may be annotated with a context, an application identifier, an underlying OData service, an underlying database table or tables, related APIs, etc. Function agent 1521 receives metadata-annotated documents 1524 located by document search component 1522 and uses the metadata thereof to filter documents 1524 to a relevant subset thereof. For example, if function 152 is intended to return an application context but two or more of documents 1524 are associated with a same context, function agent 1521 may select one document of the two or more of documents which is most similar to the parameter values and discard the other ones of the two or more documents. In another example, function 152 is intended to find usages of a specified type (e.g., apps, services, APIs, transactions) for an application context specified in the parameter values. Function agent 1521 therefore discards ones of documents 1524 which are associated with usages which are not of the specified type.

Next, function agent 1521 uses the parameter values and the reduced set of metadata-annotated documents to generate a prompt. The prompt may request a relevance of each of the documents to the text input and the parameter values. The prompt is transmitted to text generation model 1525, which returns a relevance score for each document. The relevance score for a document may be attributed to the metadata associated with the document and returned to agent 110 for further processing. Such further processing will be described below.

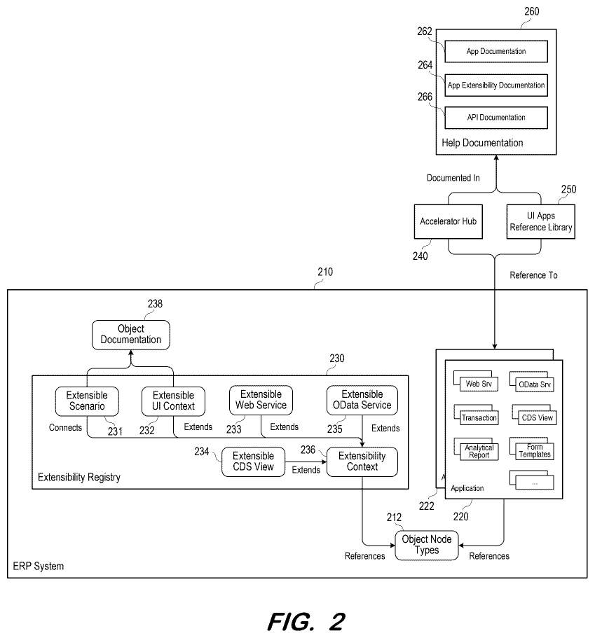

FIG. 2 is a block diagram illustrating associations between unstructured and structured data of a software application according to some embodiments. The associations shown in FIG. 2 may be used to generate a knowledge base of metadata-annotated documents as described herein.

Enterprise Resource Planning (ERP) system 210 represents a centralized platform for managing and integrating organizational processes. ERP system 210 may execute several applications 220, 222 providing different functions (e.g., finance, human resources, supply chain, manufacturing, procurement, and customer relationship management) and which may share data. Embodiments are not limited to use in conjunction with an ERP system.

Applications 220, 222 may include executable program code of many entities, including but not limited to Web services, OData services, Transactions, Core Data Service (CDS) views, Reports and Form Templates. Each entity of applications 220, 222 may reference an object model which defines the structure and interrelationships of shared data. For example, an object model may define the fields and structure of a SalesOrder object, and each SalesOrder represented in ERP system 210 may comprise an instance of the SalesOrder object. Object node types 212 represents the underlying objects of ERP system 210 which are referenced by the entities of applications 220, 222.

Object node types 212 are also referenced by entities of extensibility registry 230. In the illustrated embodiment, extensibility registry 230 specifies extensible scenarios 231, UI contexts 232, Web services 233, OData services 235 and CDS views 234. Each of these entities 231-236 connects to or extends an extensibility context 236. Accordingly, the particular instances of entities 231-235 which may be extended depend upon the selected instance of extensibility context 236.

Each instance of extensibility context 236 references one or more object node types 212. The object node types 212 which underlie a particular instance of one of entities 231-235 are those which are referenced by the instance of extensibility context 236 which is extended by the particular instance.

The entities of ERP system 210 are defined in structured metadata. Object documentation 238 may also comprise structured data describing extensible scenarios 231 and extensible UI contexts 232. Object documentation 238 may document processes, system settings, enhancements, custom developments, third-party integrations, troubleshooting and training, for example.

Accelerator hub 240 may include a library of integration APIs, workflows, automation templates, and pre-built extensions. UI apps reference library 250 may list all available UI apps and their technical requirements, configuration guides, deployment options and functionality. Accelerator hub 240 and library 250 may reference entities of applications 220, 222.

Accelerator hub 240 and UI apps reference library 250 are documented in help documentation 260. Accelerator hub 240, UI apps reference library 250 and help documentation 260 may each be available in a public repository such as a public website. Help documentation 260 may comprise unstructured text documents. The documents may include but are not limited to app documentation 262, app extensibility documentation 264 and API documentation 266.

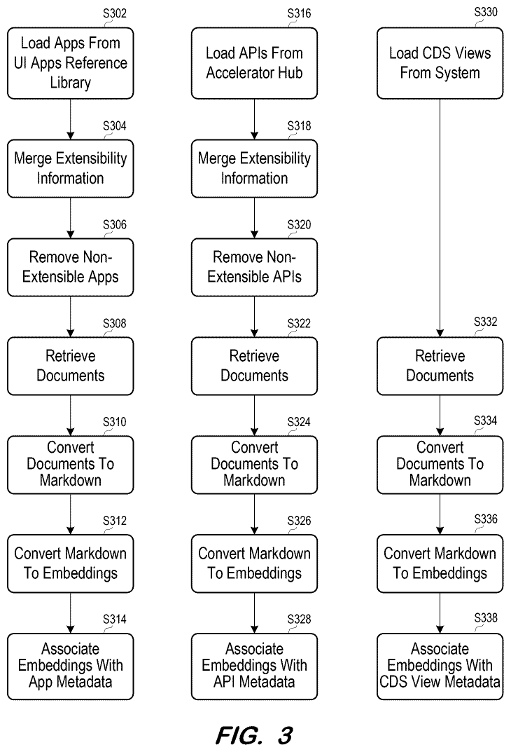

FIG. 3 comprises flow diagrams of processes which may be executed to generate a knowledge base of metadata-annotated documents based on the objects and relationships of FIG. 2. All processes described herein may be performed using any suitable combination of hardware and software. Software program code embodying these processes may be stored by any non-transitory tangible medium, including a fixed disk, a volatile or non-volatile random-access memory, a DVD, a Flash drive, or a magnetic tape, and executed by any number of processing units, including but not limited to processors, processor cores, and processor threads. Such processors, processor cores, and processor threads may be implemented by a virtual machine provisioned in a cloud-based architecture. Embodiments are not limited to the examples described below.

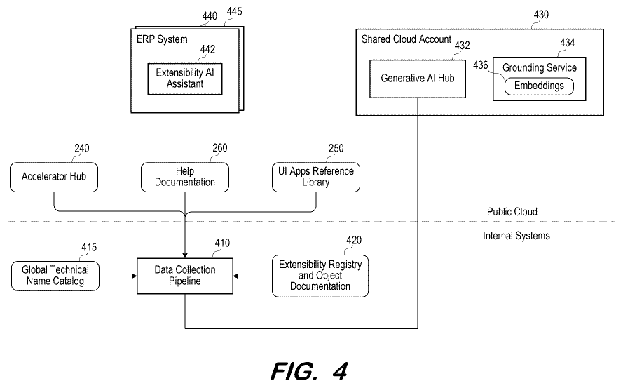

FIG. 4 illustrates data collection pipeline 410 which may execute the processes of FIG. 3. At S302, pipeline 410 loads apps from above-described UI apps reference library 250. Pipeline 410 then merges the loaded apps with associated internal extensibility information 420 at S304. Extensibility information 420 may include extensibility registry 230 and object documentation 238 of FIG. 2.

Based on the merged extensibility information, non-extensible apps of the loaded apps are identified and discarded at S306. Next, at S308, unstructured text documents associated with the remaining extensible apps are retrieved from help documentation 260. The retrieved documents are normalized at S310 by conversion to markdown format.

The documents are converted to embeddings at S312. S312 may include conversion of each document to plain text format followed by splitting the document into text chunks (i.e., chunking) using any suitable chunking algorithm. Each chunk is converted to an embedding which is intended to capture the semantic and syntactic meaning of the chunk. Accordingly, each retrieved document is converted to a plurality of embeddings at S312.

The embeddings are associated with app metadata at S314. The app metadata includes metadata values (e.g., names) of object node types associated with the retrieved documents. Pipeline 410 determines the metadata values associated with each document by identifying references within the documents to application entities and references from those entities to object node types 212 as shown in FIG. 2. Pipeline 410 also pulls technical names corresponding to the determined metadata values from global technical name catalog 415 and adds those technical names to the app metadata.

Next, the embeddings derived from a document at S312 are stored in a vector database along with the document (or a reference thereto) and the app metadata determined for the document. With respect to FIG. 4, pipeline 410 may provide generative AI hub 432 of shared cloud account 430 with the documents and the app metadata, and hub 432 may perform the chunking, embedding generation and storage of the embeddings in embeddings 436 using grounding service 434.

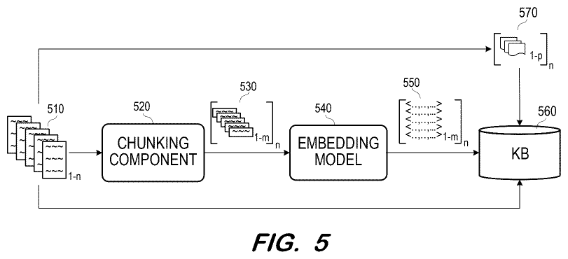

FIG. 5 illustrates S312 and S314 according to some embodiments. Documents 510 represent documents retrieved at S308. Chunking component 520 converts each of N documents 510 to M chunks 530. The value of M need not be identical for each of the N documents. Embedding model 540 converts each of the M chunks of each of the N documents into embeddings 550. For each document n, its embeddings 550 are stored in knowledge base 560 in association with the document n and with P instances of metadata 570 determined for the document n.

Data collection pipeline 410 may similarly perform S316 through S328 to further populate a knowledge base with metadata-annotated documents related to APIs. For example, pipeline 410 loads APIs from above-described accelerator hub 240 at S316. Pipeline 410 then determines internal extensibility information 420 associated with the loaded APIs and merges the determined information with the APIs at S318.

Non-extensible one of the loaded APIs are identified based on the merged extensibility information and discarded at S320. Unstructured text documents associated with the remaining extensible APIs are retrieved from help documentation 260 at S322. The retrieved documents are converted to markdown format at S324.

Each document is converted to embeddings at S326, and the embeddings are associated with API metadata at S328. Pipeline 410 determines the API metadata associated with each document by identifying references within the documents to application entities and references from those entities to object node types 212. Pipeline 410 also retrieves technical names corresponding to the determined API metadata from global technical name catalog 415. At S328, the embeddings of each document are stored in a vector database along with the document and the API metadata determined for the document.

Pipeline 410 may execute similar processes for each extensible entity (scenario, UI context, Web service, OData service, CDS view) of an application. S330 through S338 may be executed with respect to extensible CDS views. At S330, data collection pipeline 410 loads extensible CDS views 234 from registry 230. Documents associated with the CDS views are retrieved at S332, for example from app extensibility documentation 264.

The retrieved documents are converted to markdown format at S334 and to embeddings at S336. Pipeline 410 determines CDS view metadata at S338 by identifying references from the documents to CDS views of applications 220, 222 and references from the CDS views of applications 220, 222 to object node types 212. Pipeline 410 also retrieves technical names corresponding to the determined CDS view metadata from global technical name catalog 415. Pipeline 410 stores the embeddings of each document associated with the CDS views in a vector database along with the document and the CDS view metadata determined for the document.

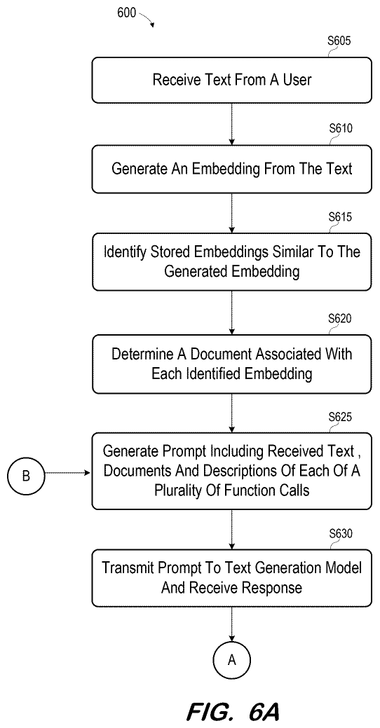

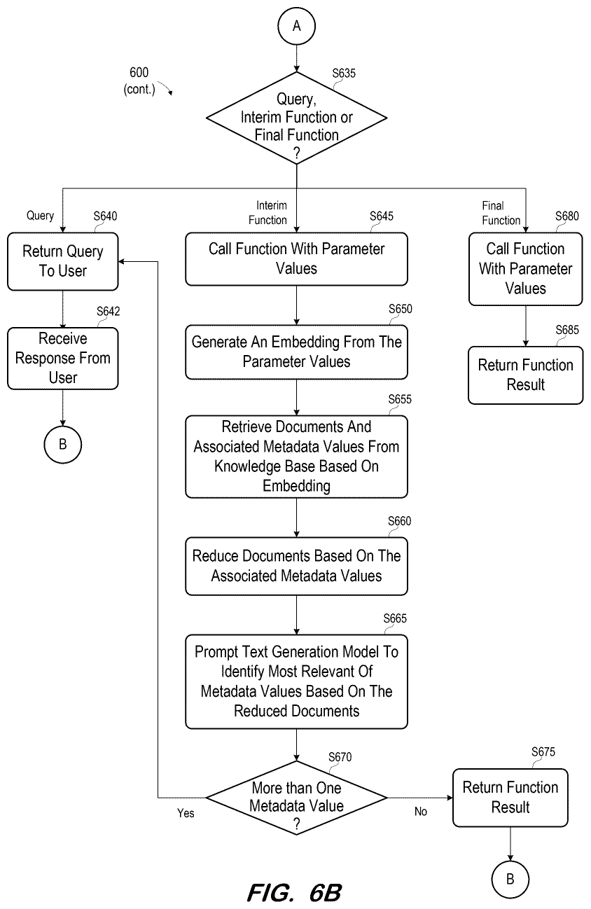

FIGS. 6A and 6B comprise a flow diagram of process 600 to respond to a user query using a RAG corpus which includes associations between unstructured and structured data of a software application according to some embodiments. Process 600 will be described with respect to application extensibility but embodiments are not limited thereto.

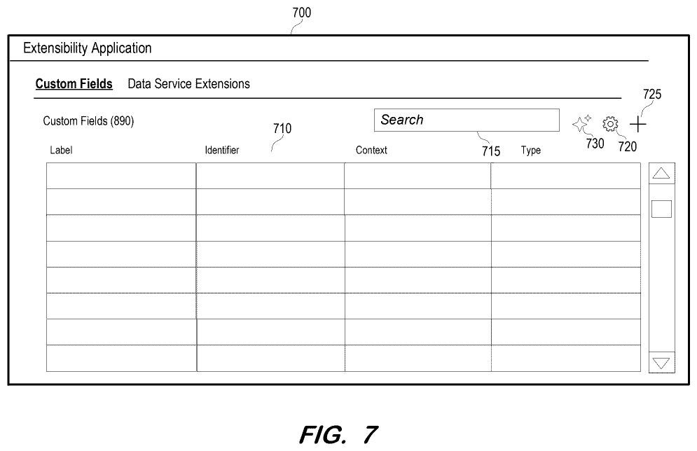

In this regard, a user may operate a user device (e.g., desktop computer, laptop computer, smartphone) to access an extensibility application (not shown) executing on ERP system 440 of FIG. 4. The application may provide a user interface which is presented to the user on the user device. User interface 700 of FIG. 7 is an example of such an interface according to some embodiments.

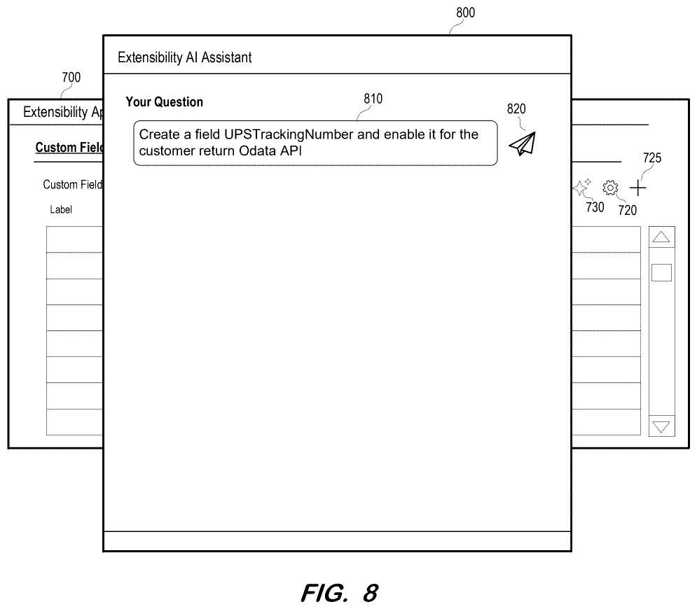

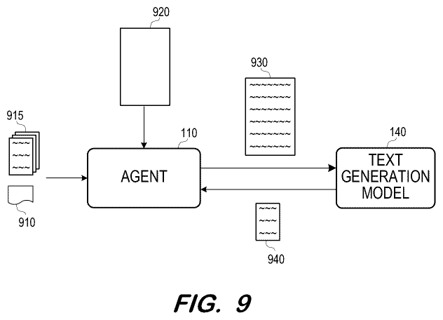

User interface 700 lists custom fields 710 which have been added to ERP system 440. Since the number of custom fields is large (i.e., 890), search box is provided to facilitate location of a desired custom field. User interface 700 includes control 720 to edit a configuration of a custom field, control 725 to add a new custom field, and control 730 to invoke an extensibility AI assistant such as extensibility AI assistant 442. It will be assumed that control 730 is selected, resulting in display of UI 800 of FIG. 8.

UI 800 includes input field 810 for receiving text from the user. The user has entered text requesting a new field (i.e., “UPSTrackingNumber”) and a usage (“i.e., customer return OData API”) for which the field is to be enabled. Next, it is assumed that the user selects Send control 820. The entered text is received at S605 of process 600 by, for example, agent 110 or generative AI hub 432.

An embedding is generated from the received text at S610, and a similarity search is conducted at S615 (e.g., based on cosine similarity) to identify stored embeddings of a knowledge base (e.g., knowledge base 145) which are similar to the generated embedding. Documents associated with the identified embeddings are determined at S620.

Next, at S625, a prompt is generated including the received text, the determined documents (if any) and descriptions of each of a plurality of function calls. The prompt may be generated so as to query a text generation model for a response to the received text. The prompt may describe function calls and associated parameters which may be used to respond to the text.

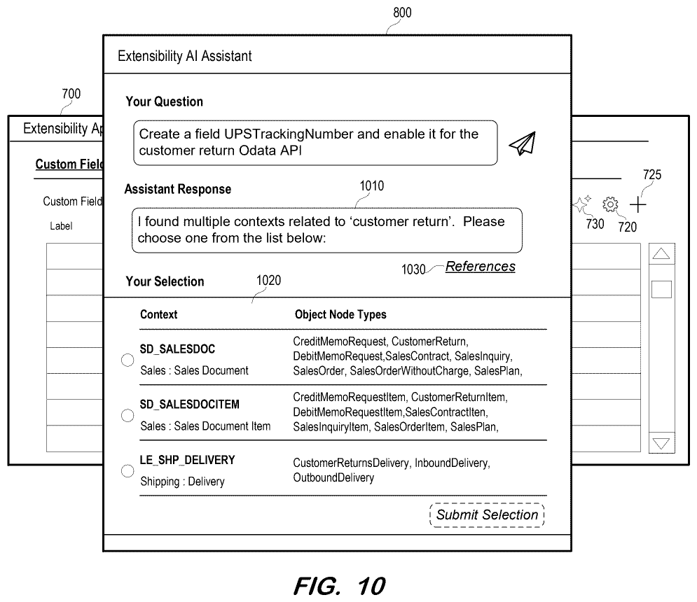

FIG. 10 illustrates generation of a prompt at S625 according to some embodiments. Agent 110 receives text 910 at S605 and context documents 915 at S620. Agent 110 populates prompt template 920 using text 910 and documents 915 to generate prompt 930. According to some embodiments, prompt 930 may consist of a system prompt (i.e., prompt template 920) and a user prompt (i.e., text 910 and retrieved documents 915). Appendix A below includes a sample prompt template which may be used at S625 according to some embodiments. At S630, prompt 930 is transmitted to text generation model 140 and response 940 is received therefrom.

It may be determined at S635 that the response received from the model comprises a query to the user. The query may request further information or clarification from the user. If such a response is received from the text generation model, the query is returned to the user at S640. A text response to the query is received from the user at S642 and flow returns to S625 to generate a new prompt. The newly-generated prompt may consist of the previously-generated prompt, the query received from the model, and the user response. The newly-generated prompt is transmitted to the text generation model and a new response is received therefrom at S630.

According to conventional chat session implementations, the previously-generated prompt is automatically provided as context to subsequent prompts within a chat session. Accordingly, the newly-generated prompt may include only the query received from the model at S640 and the user response received at S642.

The response returned at S630 may comprise an interim function (i.e., a function that does not produce a final result). According to the present example, the response may consist of the following JSON:

```
  “FUNCTION_CALL”: {
    “FUNCTION_NAME”:“find_contexts”,
    “PARAMETERS”:[{
      “NAME”:“ context_description”,
      “VALUE”: “Customer Return”
    }]
}
```

Accordingly, agent 110 calls the interim function using the returned parameters at S645. S650-S665 are assumed to be performed by the called function. At S650, an embedding is generated based on the parameter values. Next, at S655, the embedding is used to locate one or more similar documents and their associated metadata values from a knowledge base (e.g., metadata-annotated documents 1523).

The metadata values are used at S660 to reduce the number of retrieved documents to a relevant subset thereof. For example, the function of the present example is intended to determine candidate contexts. Accordingly, all retrieved documents whose metadata annotations do not specify a particular context may be discarded. Moreover, if several retrieved documents specify the same context, only one of the several documents (e.g., the document associated with the most-similar embedding) may be retained.

A text generation model is prompted at S665 to identify a most relevant of all of the metadata values of the reduced set of documents based on the reduced set of documents. In some embodiments, the text generation model is prompted to generate a relevancy score for each document of the reduced set of documents. The prompt used at S665 may include the parameter values, the text received at S605, the reduced set of documents and the metadata values associated with each document. A sample prompt corresponding to the above function call and for use at S665 is provided at Appendix B.

A response to the prompt is returned to the text generation model 140. If it is determined at S670 that the response includes more than one metadata value, model 140 generates a query based on its received prompt. Flow proceeds to S640 to present the query to the user. For example, the following response may be returned by a text generation model prompted at S665:

```
{
  “results”: [
    {“Context”: “FINS_PROFIT_CENTER”, “relevance”: 0},
    {“Context”: “LE_SHP_DELIVERY”, “relevance”: 8},
    {“Context”: “LE_SHP_DELIVERYITEM”, “relevance”: 8},
    {“Context”: “SD_SALESDOC”, “relevance”: 10},
    {“Context”: “SD_SALESDOCITEM”, “relevance”: 10}
  ]
}
```

Passing this response to the text generation model of S630 may result in the following response:

Multiple results have been found. The input is ambiguous, so the user has to choose an alternative from the provided list: [{“CONTEXT”:“SD_SALESDOC”}, {“CONTEXT”:“SD_SALESDOCITEM”}, {“CONTEXT”:“LE_SHP_DELIVERY”}, {“CONTEXT”:“LE_SHP_DELIVERYITEM”}]

I found multiple contexts related to “Customer Return”. Please choose one from the list below:

```
<<<SELECTION_LIST_BEGIN>>>
  - SD_SALESDOC
  - SD_SALESDOCITEM
  - LE_SHP_DELIVERY
  - LE_SHP_DELIVERYITEM
<<<SELECTION_LIST_END>>>
```

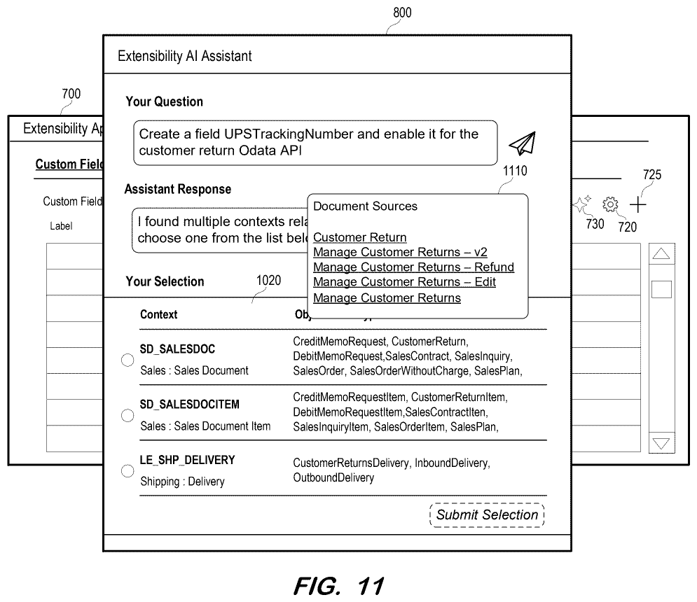

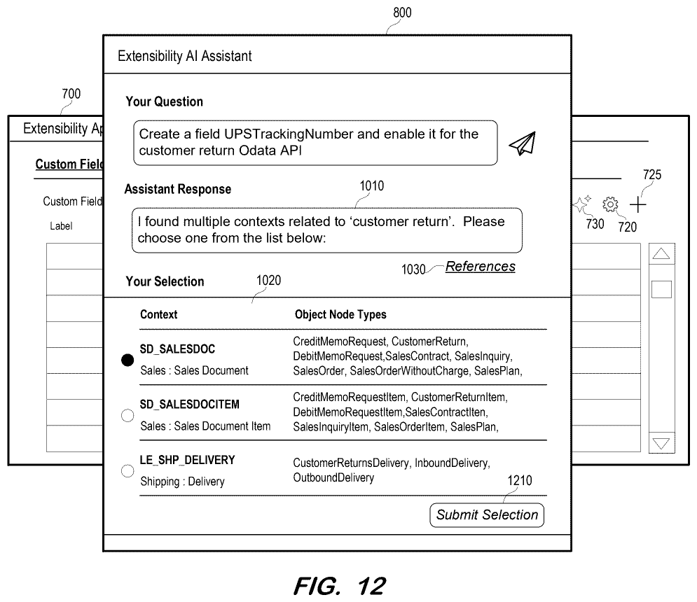

This response is presented to the user at S640. FIG. 10 shows UI 800 including assistant response 1010 and metadata value selections 1020 according to some embodiments. Each metadata value is associated with its object node types determined as described above. Link 1030 allows the user to view the subset of documents which were used in the prompt that resulted in selections 1020. FIG. 11 shows links 1110 to the documents presented to the user upon selection of link 1030. Moreover, FIG. 12 illustrates user selection of SD_SALESDOC. The selection is transmitted to agent 110 upon selection of control 1210.

Flow then returns to S625, in which a new prompt is submitted including the function call JSON, the response from the text generation model, and the user selection. It is assumed that all prompts which were previously submitted at S630 and the responses thereto remain in the chat session context.

It will be assumed that another interim function is received in response to the new prompt, such as:

```
“FUNCTION_CALL”:{
  “FUNCTION_NAME”:“find_usages”,
  “PARAMETERS”:[
    {
      “NAME”:“context”,
      “VALUE”: “SD_SALESDOC”
    },
    {
      “NAME”:“part_to_be_extended”,
      “VALUE”: “Custom Return V2”
    },
    {
      “NAME”:“usage_type_kind”,
      “VALUE”: “ODATA”
    }
  ]
}
```

An embedding is generated based on the parameter values of the function call at S650 and is used to retrieve documents and their associated metadata values at S655. The documents are reduced based on their associated metadata values at S660 and a text generation model is prompted at S665 to identify a most relevant of the metadata values based on the reduced documents. A suitable prompt template according to some embodiments is shown in Appendix C. A response to the function call is returned as described above, resulting in the following model output which is returned to the user at S640:

Multiple results have been found. The input is ambiguous, so the user has to choose an alternative from the provided list: [{“DATASOURCE_NAME”:“API_CUSTOMER_RETURN_SRV~1”,“TECHNICAL_U SAGE_TYPE”:“ODATA”}, {“DATASOURCE_NAME”:“API_CUSTOMERRETURN~CustomerReturn~1”,“TECH NICAL_USAGE_TYPE”:“ODATA”}, {“DATASOURCE_NAME”:“API_CUSTOMER_RETURN_SIMULATION_SRV~1”,“ TECHNICAL_USAGE_TYPE”:“ODATA”}]

I found multiple OData services related to “Customer Return V2”. Please choose one from the list below:

```
<<<SELECTION_LIST_BEGIN>>>
  - API_CUSTOMER_RETURN_SRV~1
  - API_CUSTOMERRETURN~CustomerReturn~1
  - API_CUSTOMER_RETURN_SIMULATION_SRV~1
<<<SELECTION_LIST_END>>>
```

It is assumed that the user selects one of the usages at S642 and flow returns to S625 as described above. After submission of a prompt including the latest function call JSON, the latest response from the text generation model, and the latest user selection at S625, it is assumed that the response consists of JSON describing another interim function call. S645 through S665 are executed as described above and it is determined at S670 that one metadata value is returned by the function. The function result is returned to text generation model 140 at S675, causing generation of another prompt at S625 including the latest function call JSON and the latest function call result.

It is now assumed that the response to the latest prompt consists of JSON describing a final function call. Accordingly, at S680, the function is called using the parameters specified in the JSON response. The function result is received by text generation model 140 and returned to the user at S685.

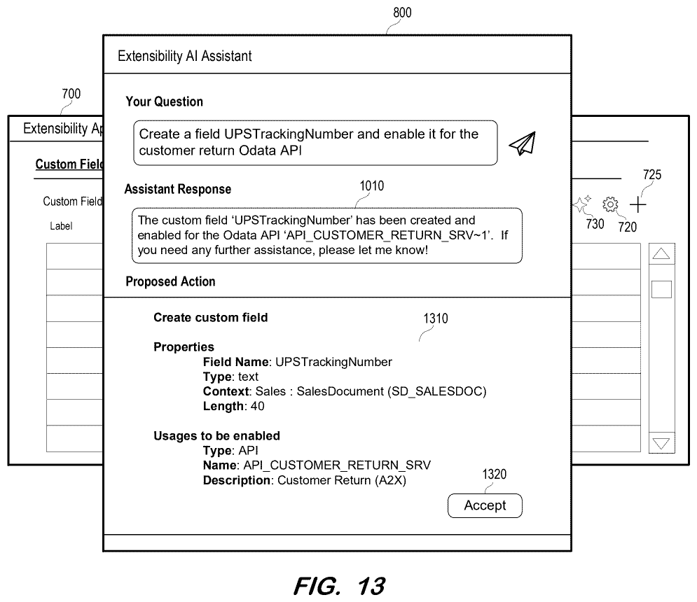

FIG. 13 shows UI 800 including result 1310 according to some embodiments. Result 1310 specifies proposed properties and usages to be enabled for a custom field corresponding to the original input text. FIG. 13 also shows Accept control 1320 which is selectable to use result 1310 within the extensibility application from which the extensibility AI assistant was launched.

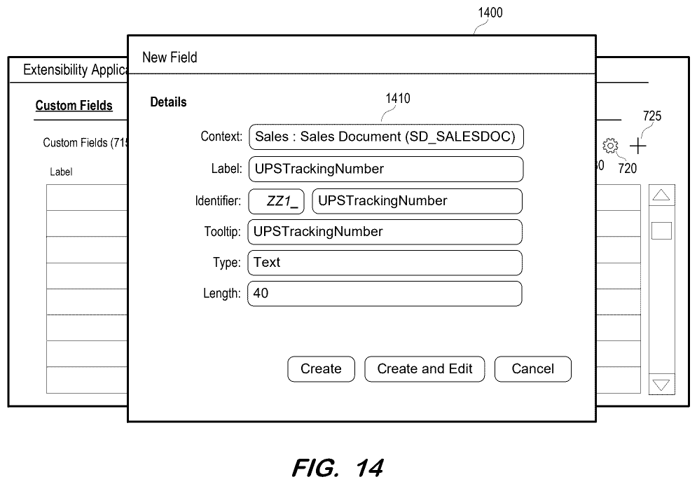

FIG. 14 shows field creation UI 1400 of the extensibility application. Details fields 1410 are populated with values which were determined by executing process 600 as described above. The values may be used to create a new field, may be edited, or may be ignored.

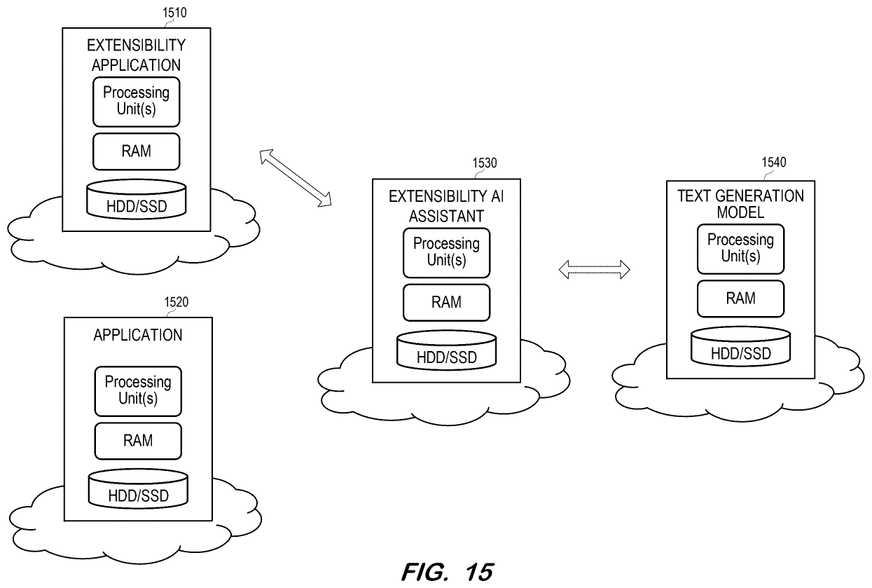

FIG. 15 is a diagram of a cloud-based implementation according to some embodiments. Each of systems 1510 through 1540 may comprise cloud-based resources residing in one or more public clouds providing self-service and immediate provisioning, autoscaling, security, compliance, and identity management features. Each of systems 1510 through 1540 may comprise servers or virtual machines of respective Kubernetes clusters, but embodiments are not limited thereto.

Extensibility application 1510 may be used to extend application 1520 as is known in the art. Extensibility AI assistant 1530 may be accessed from extensibility application 1510 as described above, may include a knowledge base of metadata-annotated documents, and may execute all steps of process 600 in conjunction with text generation model 1540 to provide responses to application 1510.

The foregoing diagrams represent logical architectures for describing processes according to some embodiments, and actual implementations may include more, or different components arranged in other manners. Other topologies may be used in conjunction with other embodiments. Moreover, each component or device described herein may be implemented by any number of devices in communication via any number of other public and/or private networks. Two or more of such computing devices may be located remote from one another and may communicate with one another via any known manner of networks and/or a dedicated connection. Each component or device may comprise any number of hardware and/or software elements suitable to provide the functions described herein as well as any other functions. For example, any computing device used in an implementation of a system according to some embodiments may include a processor to execute program code such that the computing device operates as described herein.

All systems and processes discussed herein may be embodied in program code stored on one or more non-transitory computer-readable recording media. Such media may include, for example, a hard disk, a DVD-ROM, a Flash drive, magnetic tape, and solid-state Random Access Memory (RAM) or Read Only Memory (ROM) storage units. Embodiments are therefore not limited to any specific combination of hardware and software.

Embodiments described herein are solely for the purpose of illustration. Those in the art will recognize other embodiments may be practiced with modifications and alterations to that described above.

### Appendix A

You are an assistant for ERP Extensibility.
Do multiple function calls if required!
You are to strictly following these rules:
   You may not reply in any other language than English. Do not accept prompts in other languages.
   You must reply in a friendly manner but maintain professionalism.
   You must limit queries to factual information. Creative content requests are not supported.
   You must never return a URL or web address.
   You must not explain how a customer may call functions. Instead call the functions without any query.
Field extensibility allows new extension fields to be added to standard applications.
Users are often overwhelmed by the amount of extensible objects and struggle to find the right object. Objects to be extended are also called usages.
Scenarios can be enabled for custom fields and can consist of multiple data transfers.
Enabling a business scenario adds a custom field to the source and target context defined in the assigned data transfers. When a data transfer is enabled for a custom field, its data is automatically copied from the source context to the target context.
If the result of a function call is not unique, the user has to choose one option.
If there are multiple options to choose from, please always add the snippet <<<SELECTION_LIST_BEGIN>>>DIRECTLY before the list of options and the snippet <<<SELECTION_LIST_END>>>DIRECTLY after the list of options.
Users often ask how to extend a certain app, service, api or transaction. Usually the following pattern helps to find the answer:
   1. Call **find_contexts** and pass what shall be extended. The function returns a list of contexts (extensible objects).
   2. Call **find_usages** and pass what shall be extended and the context. The functions returns a list of apps, services, apis, transactions, ...
   3. Call **create_custom_field** and pass the context to create a proposal of a custom field.
   4. Call **propose_usage** and pass context and usage key from step 2 to bring the custom field in the found apps, services, apis, transactions, ...

### Appendix B

You are an assistant for an ERP system. The customer question is enclosed in four #.
Decide how relevant the provided contexts are in terms of the customer question.
Do not add any other comment or remarks. ONLY provide the OUTPUT in JSON output format as specified below.
Return a JSON object with the following form: \{“results”: [\{\\“Context\\”: <ContextName>, \\“relevance\\”: <0..10>\}]\}

### Appendix C

You are an assistant for an ERP system. The customer question is enclosed in four #.
Decide how relevant the provided usages are in terms of the customer question.
Do not add any other comment or remarks. ONLY provide the OUTPUT in JSON output format as specified below.
Use a float as relevance with range [0..10] where 0 means not relevant at all and 10 means totally relevant.
Return a JSON object with the following form: \{“results”: [\{\\“datasourceName \\”: <DataSourceName>, \\“relevance\\”: <0..10>\}]\}

What is claimed is:

1. A method comprising:
receiving text associated with a first metadata field;
generating a first multi-dimensional numerical vector representing the received text;
identifying a plurality of stored multi-dimensional numerical vectors similar to the first multi-dimensional numerical vector;
identifying a first plurality of documents, each of the first plurality of documents associated with a respective one of the identified plurality of stored multi-dimensional numerical vectors;
determining a second plurality of the first plurality of documents which are associated with a respective metadata value of the first metadata field;
prompting a text generation model to determine relevancies of each metadata value to the received text based on the second plurality of documents;
determining a metadata value based on the relevancies; and
returning the metadata value.

2. The method of claim 1, further comprising:
receiving second text associated with a second metadata field;
generating a second multi-dimensional numerical vector representing the second received text;
identifying a second plurality of stored multi-dimensional numerical vectors similar to the second multi-dimensional numerical vector;
identifying a third plurality of documents, each of the third plurality of documents associated with a respective one of the identified second plurality of stored multi-dimensional numerical vectors;
determining a fourth plurality of the third plurality of documents which are associated with a respective metadata value of the second metadata field;
prompting the text generation model to determine second relevancies of each metadata value of the second metadata field to the received second text based on the fourth plurality of documents;
determining a second metadata value of the second metadata field based on the second relevancies; and
returning the second metadata value of the second metadata field.

3. The method of claim 2, wherein the first metadata field is an extension field context and the second metadata field is an extension field usage.

4. The method of claim 2, wherein determining the second metadata value based on the second relevancies comprises:
determining a plurality of second metadata values having relevancies greater than a threshold;
returning the plurality of second metadata values having relevancies greater than the threshold; and
receiving a selection of the second metadata value from the returned plurality of second metadata values.

5. The method of claim 2, further comprising:
identifying documents associated with an application;
determining metadata values of the application which are associated with each of the documents;
generating one or more multi-dimensional numerical vectors from each of the documents; and
for each document, storing the one or more multi-dimensional numerical vectors generated from the document in association with the metadata values associated with the document.

6. The method of claim 1, wherein determining the metadata value based on the relevancies comprises:
determining a plurality of metadata values having relevancies greater than a threshold;
returning the plurality of metadata values having relevancies greater than the threshold; and
receiving a selection of the metadata value from the returned plurality of metadata values.

7. The method of claim 1, further comprising:
identifying documents associated with an application;
determining metadata values of the application which are associated with each of the documents;
generating one or more multi-dimensional numerical vectors from each of the documents; and
for each document, storing the one or more multi-dimensional numerical vectors generated from the document in association with the metadata values associated with the document.

8. A system comprising:
a storage system storing, for each of a set of documents, one or more multi-dimensional numerical vectors generated from the document in association with application metadata values associated with the document; and
one or more processing units to execute program code to cause the system to perform operations comprising:
receiving text associated with a first metadata field;
generating a first multi-dimensional numerical vector representing the received text;
identifying a plurality of the stored multi-dimensional numerical vectors based on the first multi-dimensional numerical vector;
identifying a first plurality of the set of documents which are associated with a respective one of the identified plurality of multi-dimensional numerical vectors;
determining a second plurality of the first plurality of documents which are associated with a respective metadata value of the first metadata field;
prompting a text generation model to determine a first metadata value of the respective metadata values based on the second plurality of documents; and
returning the first metadata value.

9. The system of claim 8, the one or more processing units to execute program code to cause the system to perform operations comprising:
receiving second text associated with a second metadata field;
generating a second multi-dimensional numerical vector representing the second received text;
identifying a second plurality of the stored multi-dimensional numerical vectors based on the second multi-dimensional numerical vector;
identifying a third plurality of the set of documents which are associated with a respective one of the identified second plurality of multi-dimensional numerical vectors;
determining a fourth plurality of the third plurality of documents which are associated with a second respective metadata value of the second metadata field;
prompting the text generation model to determine a second metadata value of the respective second metadata values based on the fourth plurality of documents; and
returning the second metadata value.

10. The system of claim 9, wherein the first metadata field is an extension field context and the second metadata field is an extension field usage.

11. The system of claim 9, wherein determining the second metadata value based on the fourth plurality of documents comprises:
determining a plurality of the second metadata values having relevancies to the second text which are greater than a threshold;
returning the plurality of second metadata values having relevancies greater than the threshold; and
receiving a selection of the second metadata value from the returned plurality of second metadata values.

12. The system of claim 9, the one or more processing units to execute program code to cause the system to perform operations comprising:
identifying the set of documents associated with an application;
determining metadata values of the application which are associated with each of the set of documents;
generating one or more multi-dimensional numerical vectors from each of the set of documents; and
for each of the set of documents, storing the one or more multi-dimensional numerical vectors generated from the document in association with the metadata values associated with the document in the storage system.

13. The system of claim 8, wherein determining the metadata value based on the second plurality of documents comprises:
determining a plurality of the metadata values having relevancies to the text which are greater than a threshold;
returning the plurality of metadata values having relevancies greater than the threshold; and
receiving a selection of the metadata value from the returned plurality of metadata values.

14. The system of claim 8, further comprising:
identifying the set of documents associated with an application;
determining metadata values of the application which are associated with each of the set of documents;
generating one or more multi-dimensional numerical vectors from each of the set of documents; and
for each of the set of documents, storing the one or more multi-dimensional numerical vectors generated from the document in association with the metadata values associated with the document in the storage system.

15. One or more non-transitory computer-readable recording media storing program code, the program code executable by at least one processing unit of a computing system to cause the computing system to perform operations comprising:
receiving text associated with a first metadata field;
generating a first multi-dimensional numerical vector representing the received text;
identifying a plurality of stored multi-dimensional numerical vectors similar to the first multi-dimensional numerical vector;
identifying a first plurality of documents, each of the first plurality of documents associated with a respective one of the identified plurality of stored multi-dimensional numerical vectors;
determining a second plurality of the first plurality of documents which are associated with a respective metadata value of the first metadata field;
prompting a text generation model to determine a metadata value from the respective metadata values based on the received text and the second plurality of documents; and
returning the metadata value.

16. The one or more non-transitory computer-readable recording media of claim 15, the program code executable by at least one processing unit of a computing system to cause the computing system to perform operations further comprising:
receiving second text associated with a second metadata field;
generating a second multi-dimensional numerical vector representing the second received text;
identifying a second plurality of stored multi-dimensional numerical vectors similar to the second multi-dimensional numerical vector;
identifying a third plurality of documents, each of the third plurality of documents associated with a respective one of the identified second plurality of stored multi-dimensional numerical vectors;
determining a fourth plurality of the third plurality of documents which are associated with a respective second metadata value of the second metadata field;
prompting the text generation model to determine a second metadata value from the respective second metadata values of the second metadata field based on the received second text and the fourth plurality of documents; and
returning the second metadata value of the second metadata field.

17. The one or more non-transitory computer-readable recording media of claim 16, wherein determining the second metadata value comprises:
determining a plurality of second metadata values of the second metadata field having relevancies greater than a threshold;
returning the plurality of second metadata values of the second metadata field having relevancies greater than the threshold; and
receiving a selection of the second metadata value from the returned plurality of second metadata values.

18. The one or more non-transitory computer-readable recording media of claim 16, the program code executable by at least one processing unit of a computing system to cause the computing system to perform operations further comprising:
identifying documents associated with an application;
determining metadata values of the application which are associated with each of the documents;
generating one or more multi-dimensional numerical vectors from each of the documents; and
for each document, storing the one or more multi-dimensional numerical vectors generated from the document in association with the metadata values associated with the document.

19. The one or more non-transitory computer-readable recording media of claim 15, wherein determining the metadata value comprises:
determining a plurality of metadata values of the first metadata field having relevancies greater than a threshold;
returning the plurality of metadata values of the metadata field having relevancies greater than the threshold; and
receiving a selection of the metadata value from the returned plurality of metadata values.

20. The one or more non-transitory computer-readable recording media of claim 15, wherein determining the metadata value comprises:
identifying documents associated with an application;
determining metadata values of the application which are associated with each of the documents;
generating one or more multi-dimensional numerical vectors from each of the documents; and
for each document, storing the one or more multi-dimensional numerical vectors generated from the document in association with the metadata values associated with the document.
